(19) United States
(12) Patent Application Publication
(10) Pub. No.: US 2011/0311807 A1
(43) Pub. Date: Dec. 22, 2011

(54) FLEXIBLE SUBSTRATES HAVING REDUCED SHRINKAGE AND CURLING

(75) Inventors: Pei Wen Jin, Cary, NC (US); Kimberley Rae Benca, Clayton, NC (US); Ian Christopher Quarmby, Apex, NC (US); Thomas Kurpiewski, Erie, PA (US)

(73) Assignee: Akzo Nobel Coatings International B.V., Arnhem (NL)

(21) Appl. No.: 12/997,944

(22) PCT Filed: Jun. 22, 2009
(86) PCT No.: PCT/US2009/048088

§ 371 Date: Jan. 20, 2011

Related U.S. Application Data
(60) Provisional application No. 61/074,186, filed on Jun. 20, 2008.

(51) Int. Cl. B32B 3/00; B32B 27/38; C09D 4/02; B32B 27/00; C09D 163/00; C09D 7/12

(52) U.S. Cl. 428/336; 522/170; 522/15; 522/8; 522/83; 428/500; 428/413

(57) ABSTRACT

The claimed invention relates to a flexible substrate having reduced shrinkage and curling, wherein said substrate is coated with a coating having a dual cure system, wherein said coating comprises a free radical curable component and a cationically curable component.

### FIELD OF THE INVENTION

The present invention relates to coatings with dual cure mechanisms. More particularly, the present invention relates to the use of a free-radical curable component and a cationically curable component, which when used together reduce or eliminate polymerization shrinkage of the coating the resulting curling of flexible substrates. Further, the abrasion resistance of the coatings can be improved greatly when the coatings are combined with certain inorganic filler materials. The coatings have utility on materials such as wood, medium density fiberboard, rigid plastics such as PVC, flooring, decorative tiles, home furnishings such as cabinets, furniture, and paneling, and machinery, appliance, and equipment housings, to name a few advantageous uses.

### BACKGROUND OF THE INVENTION

Attempts have been made in the art to improve abrasion resistance in surface coatings. For example, WO 00/39042 describes a surface covering comprising at least one layer containing wear-resistant particles, such as aluminum oxide. The particle size of the wear-resistant particles is from about 10 microns to about 350 microns, and more preferably from about 20 microns to about 250 microns, and most preferably from about 30 microns to 200 microns. Wear resistance is determined by abrasion tests such as the Taber abrasion test and the effect of the particles in the surface coating is described as providing abrasion resistance.

Likewise, EP 235 914 describes coating compositions for producing a texture finish onto a substrate, the composition comprising an adhesion promoter for promoting adhesion to the substrate, a radiation-curable component and a texture modifying amount of microspheres substantially homogeneously dispersed therein. The microspheres can be glass and/or ceramic and/or polymeric materials. The incorporation of fine glass, ceramic or polymeric solid beads or hollow spheres into a suitable radiation-curable component which, on curing, sets to form a matrix holding the beads or spheres on the substrate, enables a textured appearance to be provided and an abrasion resistance comparable to prior art methods. The particle size of the microspheres is up to 120 microns and more particularly from 15 to 60 microns and advantageously about 30 microns.

Thus, there have been attempts to provide greater abrasion resistance in coatings. However, these attempts have required the use of harder polymers, reactive systems or texture-modifying systems. Thus, there is still a need in the art for coatings which provide improved abrasion resistance without negatively impacting other physical properties of the coating such as color, flexibility, gloss, gloss retention, impact resistance, opacity, and stain resistance. It is to these perceived needs that the present invention is directed.

### SUMMARY OF THE INVENTION

The coatings of the various embodiments of the present invention find particular utility in resilient floor applications. Wear-through resistance is one of the key performance requirements to for floor coatings. As is known in the art, a harder coating system has good resistance to wear, however harder coatings are generally obtained through free radical polymerization of acrylic monomers to form the coating. Unfortunately, free radical polymerization of acrylic monomers leads to volume shrinkage during polymerization, which can cause a substrate to curl. This issue is particularly problematic in resilient flooring, such as vinyl flooring, or other thin flexible substrates.

The present invention overcomes this unwanted curling by providing a ring-opening polymerization through a cationically curable epoxy in addition to the traditional free-radical curable acrylic monomers for strength. The result is a coating with excellent adhesion to the substrate and low curl due to reduced or eliminated shrinkage during the cure/polymerization. The balance between the volume-reducing cure of the acrylate monomer and volume-increasing cure of the ring-opening epoxide polymerization provides this important technical advantage. This dual cure system has excellent adhesion, and can greatly improve the wear-through resistance of the vinyl composition tile without showing curl.

### DETAILED DESCRIPTION OF THE PREFERRED EMBODIMENTS

In a first aspect of the present invention, a dual cure coating composition is provided comprising radiation curable free-radical and cationic cure mechanisms. In a further embodiment of the present invention, the radiation curable coating system in combination with an abrasion resistant filler is provided to significantly improve the wear-through resistance when applied to vinyl composition tile and tested by S-42 sand paper on a Taber Abrasion Tester.

In a further aspect of the present invention, the coating comprises a free radical curable acrylate, a cationic curable cycloaliphatic epoxide, a free-radical photoinitiator and a cationic photoinitiator. It is believed that the free radical cure provides strength and hardness to the coating, while the cationic cure epoxide helps to prevent shrinkage of the curing coating and associated curl of the substrate. In another embodiment of the present invention, the composition further comprises typical additives such as fillers, wetting agents, and flow aids.

In one embodiment of the present invention, the free radical curable acrylate comprises an acrylic monomer or oligomer. In a preferred embodiment of the present invention, the free radical curable acrylate comprises poly functional acrylate monomers. Monomeric di-, tri-, tetra-, penta-, and hexafunctional acrylates, useful for the preparation of the oligomers of this invention as starting materials are for example 1,4-butandiol diacrylate, 1,6-hexandiol diacrylate, dipropylenglycol diacrylate, neopentylglycol diacrylate, ethoxylated neopentylglycol diacrylate, propoxylated neopentylglycol diacrylate, tripropylene glycol diacrylate, bisphenol-A diacrylate, ethoxylated bisphenol-A diacrylate, poly(ethylene)glycol diacrylate, trimethylolpropane triacrylate, ethoxylated trimethylolpropane triacrylate, propoxylated trimethylolpropane triacrylate, propoxylated glycerol triacrylate, tris(2-hydroxyethyl)isocyanurate triacrylate, pentaerythritol triacrylate, ethoxylated pentaerythritol triacrylate, pentaerythritol tetraacrylate, ethoxylated pentaerythritol tetraacrylate, ditrimethylolpropane tetraacrylate, dipentaerythritol pentaacrylate, dipentaerythritol hexaacrylate or mixture thereof.

In a preferred embodiment of the present invention, the free radical curable component comprises about 35 to about 80 weight percent of the total coating formulation. In another preferred embodiment of the present invention, the free radical curable component comprises from about 40 to about 50 weight percent of the total coating formulation.

The free-radical photoinitiator selected for use in a particular embodiment of the present invention will depend upon the coating composition and the use of the coating. In a preferred embodiment of the present invention, the free-radical photoinitiators comprise initiators designed for use with standard mercury lamps such as those found in the AETEK® UV processors available from Aetek UV systems, Inc., Romeoville, 111. Preferred examples of photoinitiators include acetophenone, benzophenone, 2,2-dialkoxybenzophenones, alpha-hydroxyketone initiators such as 1-hydroxy phenyl ketones, for example 1-hydroxycyclohexyl phenyl ketone or 2-hydroxy-isopropyl phenyl ketone (=2-hydroxy-2,2-dimethylacetophenone).

In another embodiment of the present invention, the cationically curable constituent comprises an epoxy, preferably a polyfunctional epoxy. Examples include: aliphatic, aromatic, cycloaliphatic, araliphatic or heterocyclic epoxies. In a preferred embodiment of the present invention, the cationically cured ring-opening constituent comprises a cycloaliphatic epoxide. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate, and the like. Other suitable diepoxides of cycloaliphatic esters of dicarboxylic acids are described in, for example, U.S. Pat. No. 2,750,395, which is incorporated herein by reference.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexylmethyl-3,4-epoxy-1-methylcyclohexane carboxylate; 6-methyl-3,4-epoxy cyclohexylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate and the like. Other suitable 3,4-epoxycyclohexylmethyl-3,4-epoxycyclohexane carboxylates are described in, for example, U.S. Pat. No. 2,890,194, which is incorporated herein by reference.

In a preferred embodiment of the present invention, the cationically cured component of the present invention comprises from about 10 to about 40 weight percent based on the total weight of the coating. In another preferred embodiment of the present invention, the cationically cured component of the present invention comprises from about 12 to about 18 weight percent based on the total weight of the coating.

Photoinitiators for use with cycloaliphatic epoxides are known in the art and the choice of photoinitiator can be tailored to the particularly desired cure conditions. Photoinitiators which can be used include, but are not limited to, iodonium salts, sulfonium salts, diazonium salts, (also known as organohalogenides) and thioxanthonium salts. Examples of specific photoinitiators for cycloaliphatic epoxies include triarylsulfonium salts (e.g. hexafluoroantimonate, hexafluorophosphate, tetrafluoroborate, hexafluoroarsenate, trifluoromethanesulfonate, and 9,10-dimethoxyantrasulfonate salts); diaryliodonium salts (e.g. tetrafluoroborate, hexafluorophosphate, hexafluoroarsenate, hexafluoroantimonate, trifluoromethanesulfonate, and 9,10-dimethoxyantrasulfonate salts); ferrocenium salts; and azoisobutyronitrile (AIBN).

The amount of free radical photoinitiator and cationic photoinitiator will vary depending upon the monomers and resins employed, however generally the photoinitiators will be present from about 0.1 to about 5.0 percent by weight, and preferably from about 0.5 to 2.5 percent by weight, based on the total weight of the composition

In a preferred embodiment of the present invention, the abrasion resistant filler comprises aluminum oxide. In another embodiment of the present invention, suitable abrasion resistant fillers comprise carborundum, quartz, silica (sand), glass particles, glass beads, glass spheres (hollow and/or filled), plastic grits, silicon carbide, diamond dust (glass), hard plastics, reinforced polymers, organics, and the like.

In a further embodiment of the present invention, the abrasion resistant filler comprises an average particle size of 10-40 microns. However, one of skill in the art will recognize the need to vary the size of the filler depending upon the final desired thickness of the coating. In another embodiment of the present invention, the abrasion resistant filler is optional comprising up to about 50 percent by weight of the total coating composition. In a preferred embodiment of the present invention, the abrasion resistant filler comprises from about 25 to about 35 percent by weight of the total coating composition.

In a further embodiment of the present invention, the coating is applied to a substrate, such as a flooring product, and a top coat is disposed thereon to provide enhanced abrasion resistance. In a further embodiment of the present invention, a sealer coat is employed between the basecoat of the invention and a topcoat. The sealer coat preferably comprises a free-radical curable component and a cationically curable component, photoinitiators, and optional wetting agents. There is a synergistic relationship in employing a sealer coat with dual cure chemistry over top of a basecoat having the same or similar chemistry. In a further preferred embodiment of the present invention, the sealer coat is substantially absent matting agents, scratch resistant fillers or other particulate additives.

The coatings of the various embodiments of the present invention may be used on a variety of substrates but have been found particularly useful on substrates commonly used for paneling, cabinets and flooring. Synthetic substrates include a variety of polymeric substrates formed from well known polymers such as PVC, ABS, ASA, PS, HIPS, PC, PO, Acrylic, SMC and the like. The abrasion resistant coating compositions of the various embodiments of the present invention preferably are utilized in the manufacture of resilient flooring, particularly polyvinyl chloride resilient flooring materials used in the production of plank, tiles and sheet vinyl. A resilient flooring as a substrate for the coatings can itself have an embossed texture or have no embossed textured, and typically has at least a resilient support layer, a wear surface and a topcoat over the wear surface. Resilient flooring may have additional layers present for providing additional wear resistance or for strengthening the flooring. The abrasion resistant coating compositions of the various embodiments of the present invention are particularly useful as the topcoat of resilient flooring, preferably embossed or unembossed vinyl flooring.

In one embodiment of the present invention, the coating comprising a free-radical curable component and a cationically curable component is employed as a resilient floor coating. The coating has demonstrated utility as both a basecoat, optionally containing an abrasion resistant filler, and as a sealer coat applied directly to the basecoat. In an embodiment as a sealer coat, the coating generally does not comprise abrasion resistant fillers. Floor coatings are generally applied to an average thickness of 10 to 40 microns when used as a basecoat, and 5 to 20 microns when used as a sealer coat. Whether or not a sealer coat is employed, a top coat is generally further applied to a thickness of 5 to 20 microns.

The invention will now be illustrated by the following non-limiting examples.

### EXAMPLES

TABLE 1
Specific Embodiments of the Invention

| | | Basecoat | Sealer |
|---|---|---|---|
| Raw Material | Function | A | Coat B |
| Pentaerythritol | Acrylic monomer | 46 | 60.6 |
| tetraacrylate | | | |
| Pentaerythritol triacrylate | Acrylic monomer | — | 9.1 |
| 3,4- | Cycloaliphatic epoxy | 16.8 | 24.5 |
| Epoxycyclohexylmethyl-3, | resin | | |
| 4-epoxycyclohexane | | | |
| carboxylate | | | |
| Mixed triarylsulfonium | Cationic initiator | 1.05 | 1.5 |
| hexafluoroantimonate salt | | | |
| 1-hydroxycyclohexyl | Free radical initiator | 1.4 | 2 |
| phenyl ketone | | | |
| Benzophenone | Free radical initiator | 1.4 | 2 |
| wetting agent | Wetting agent | 0.35 | 0.3 |
| Silicon Dioxide (6.0 urn) | Matting agent | 3.0 | — |
| Aluminum Oxide (30 um) | Abrasion resistant | 30 | — |
| | filler | | |

Basecoat A is a coating according to an embodiment of the present invention containing aluminum oxide as an abrasion resistant filler.
Sealer Coat B is a coating according to an embodiment of the present invention without particulate fillers.

TABLE 2
Comparative Formulations

| | Prior Art | Prior Art | Standard |
|---|---|---|---|
| | Basecoat | Topcoat | Topcoat |
| Acrylated Urethane | 30 | 30 | 24 |
| oligomer | | | |
| Acrylated monomers | 33.46 | 62.68 | 50 |
| Free radical | 2.48 | 5.5 | 4.5 |
| photoinitiators | | | |
| Wetting agent | 2.06 | 1.82 | 1.5 |
| Filler | 29 | | 20 |
| Silica | 2 | | |

For Samples 1-3 in Table 3 below, the basecoats according to an embodiment of the invention and the prior art were applied to vinyl composition tile at 1 ml thickness by roll coater. The coated tile was cured under UV light through Aetek processor at 1000 mJ/cm2.

The samples were tested using the NALFA test method, which is a test created by the North American Laminate Flooring Association. This test measures the ability of laminate flooring to resist abrasive wear-through. The test uses the Taber Abrasion tester and applies S-42 sand paper to the wheels with 500 gram weights. The paper is changed every 200 cycles and wear through is determined when a visible spot greater than or equal to 0.6 mm² is seen in 3 quadrants of the tile.

TABLE 3
Results

| | Basecoat | Topcoat | Sealer Coat | |
|---|---|---|---|---|
| Sample # | (1 mil) | (0.5 mil) | (0.5 mil) | NALFA |
| 1 | Prior Art | Prior Art | no | <50 cycles |
| 2 | Basecoat A | Topcoat | no | 600 cycles |
| 3 | Basecoat A | Topcoat | Sealer Coat B | 800 cycles |

Comparing Samples 1 and 2, the Basecoat A according to an embodiment of the present invention with a standard preferred topcoat, performed significantly better than the Prior Art basecoat with a Prior Art topcoat.

Comparing Samples 2 and 3, the Basecoat A according to an embodiment of the present invention was compared with and without a Sealer Coat B according to an embodiment of the present invention, both samples having the same topcoat for comparison purposes. Sample 3 including the Sealer Coat B showed further improvement when employed with the Basecoat A.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

We claim:

1. A flexible substrate having reduced shrinkage and curling, wherein said substrate is coated with a coating having a dual cure system, wherein said coating comprises a free radical curable component and a cationically curable component.

2. The flexible substrate of claim 1 wherein said free-radical curable component comprises a free-radical curable acrylate.

3. The flexible substrate of claim 1 wherein the free radical curable acrylate comprises polyfunctional acrylate monomer.

4. The flexible substrate of claim 1 wherein the cationically curable component comprises an epoxy resin.

5. The flexible substrate of claim 1 wherein the cationically curable component comprises a polyfunctional epoxy.

6. The flexible substrate of claim 1 wherein said coating further comprises a cationic photoinitiator, a free radical photoinitiator, or a mixture thereof.

7. The flexible substrate of claim 6 wherein the cationic photoinitiator comprises a triarylsulfonium salt.

8. The flexible substrate of claim 6 wherein the free-radical photoinitiator comprises a photoinitiator based on 1-hydroxy phenyl ketone.

9. The flexible substrate of claim 1 wherein the coating further comprises at least one abrasion resistant filler.

10. The flexible substrate of claim 9 wherein the abrasion resistant filler comprises at least one of carborundum, quartz, silica (sand), glass particles, glass beads, glass spheres (hollow and/or filled), plastic grits, silicon carbide, diamond dust (glass), hard plastics, and reinforced polymers.

11. The flexible substrate of claim 9 wherein the abrasion resistant filler comprises aluminum oxide.

12. The flexible substrate of claim 9 wherein the abrasion resistant filler comprises an average particle size between 10 and 40 microns.

13. The flexible substrate of claim 1 wherein said flexible substrate is comprises vinyl.

14. The flexible substrate of claim 13 wherein said flexible substrate is vinyl flooring or vinyl composition tile.

15. A resilient vinyl substrate having a reduced tendency to curl and/or shrink, said substrate coated with a dual cure coating system comprising a free radical curable component and a cationically curable component.

16. The vinyl substrate of claim 15 wherein said free-radical curable component comprises a free-radical curable acrylate and said cationically curable component comprises an epoxy resin.

17. The vinyl substrate of claim 15 wherein said coating system further comprises a cationic photoinitiator, a free-radical photoinitiator, or a mixture thereof.

18. The vinyl substrate of claim 17, wherein said substrate is vinyl flooring and/or vinyl composition tile.

19. A coating composition for vinyl flooring having reduced shrinkage and curl, said coating comprising a free radical curable component and a cationically curable component, wherein said coating composition further comprises comprises a cationic photoinitiator, a free radical photoinitiator, or a mixture thereof.

20. The coating of claim 19 wherein said free-radical curable component comprises a free-radical curable a

21. The coating of claim 19 applied to an average thickness of 10 to 40 microns.

22. The coating of claim 19 applied to a flooring substrate comprising a top coat applied thereon.

23. The coating of claim 22 further comprising a sealer coat disposed between the coating and the top coat.

24. The coating of claim 21, wherein the filler component comprises a scratch resistant agent and a matting agent.

25. A cured coating disposed on a substrate, said coating comprising in its uncured form a free radical curable component, a cationically curable component, a free radical photoinitiator and a cationic photoinitiator.
